(19) United States
(12) Patent Application Publication
(10) Pub. No.: US 2025/0201831 A1
(43) Pub. Date: Jun. 19, 2025

(54) NEGATIVE ELECTRODE ACTIVE MATERIAL FOR SECONDARY BATTERIES, AND SECONDARY BATTERY

(71) Applicants: Panasonic Energy Co., Ltd., Moriguchi-shi, Osaka (JP); Panasonic Holdings Corporation, Kadoma-shi, Osaka (JP)

(72) Inventors: Toshiki Kamidaira, OSAKA FU (JP); Taisuke Asano, HYOGO KEN (JP)

(73) Assignees: Panasonic Energy Co., Ltd., Moriguchi-shi, Osaka (JP); Panasonic Holdings Corporation, Kadoma-shi, Osaka (JP)

(21) Appl. No.: 18/844,614

(22) PCT Filed: Mar. 3, 2023
(86) PCT No.: PCT/JP2023/008173

§ 371 Date: Sep. 6, 2024

(30) Foreign Application Priority Data
Mar. 9, 2022 (JP) 2022-036469

(51) Int. Cl. H01M 4/485; H01M 4/02; H01M 4/131; H01M 4/134; H01M 4/36; H01M 4/38

(52) U.S. Cl. CPC H01M 4/485; H01M 4/131; H01M 4/134; H01M 4/364; H01M 4/386; H01M 2004/021; H01M 2004/027

(57) ABSTRACT

A negative electrode active material for secondary batteries includes silicate composite particles. The silicate composite particles each include a lithium silicate phase containing lithium, silicon, and oxygen, a silicon oxide phase including SiO₂, and a silicon phase, in which the silicon oxide phase and the silicon phase are dispersed in the lithium silicate phase. In a diffraction pattern by X-ray diffraction analysis (XRD), a ratio I_{A}/I_{B} of a maximum intensity I_{A} of a diffraction peak A attributed to the SiO₂ (011) plane of the silicon oxide phase appearing at around 2θ=26°, to a maximum intensity I_{B} of a diffraction peak B attributed to the Si (111) plane of the silicon phase appearing at around 2θ=28° is 0.9 or more and 1.4 or less.

### TECHNICAL FIELD

The present disclosure relates to a negative electrode active material for secondary batteries, and a secondary battery.

### BACKGROUND ART

Nonaqueous electrolyte secondary batteries, especially lithium-ion secondary batteries, because of their high voltage and high energy density, have been expected as power sources for small consumer applications, power storage devices, and electric cars. With increasing demand for higher battery energy density, a material containing silicon (Si) that forms an alloy with lithium has been expected to be utilized as a negative electrode active material having high theoretical capacity density.

Patent Literature 1 proposes to use, in a nonaqueous electrolyte secondary battery, a negative electrode active material including a lithium silicate phase represented by Li_{2z}SiO_{2+z} where 0<z<2, and silicon particles dispersed in the lithium silicate phase.

### CITATION LIST

### Patent Literature

Patent Literature 1: International publication WO2016/35290

### SUMMARY OF INVENTION

### Technical Problem

The composite particles disclosed in Patent Literature 1 each including a lithium silicate phase and silicon particles dispersed in the lithium silicate phase, as compared to a composite material (SiOₓ) including fine silicon dispersed in SiO₂ phase, has a small irreversible capacity during charging and discharging, and is advantageous in improving the initial charge-discharge efficiency.

The above composite particles, however, are known to undergo considerable expansion and contraction of silicon particles during charging and discharging, in association with absorption and release of lithium thereinto and therefrom. Therefore, the lithium silicate phase present around the silicon particles is subjected to a large stress along with the expansion and contraction of the silicon particles, which causes cracks or breaks in the composite particles. In association therewith, the binding force between the composite particles and the surrounding binder decreases, and especially, the broken composite particles lose the conductive path with the surrounding particles, to be isolated, causing deterioration in the charge and discharge cycle characteristics.

### Solution to Problem

In view of the above, one aspect of the present disclosure relates to a negative electrode active material for secondary batteries, including: silicate composite particles, wherein the silicate composite particles each include a lithium silicate phase, a silicon oxide phase, and a silicon phase, the lithium silicate phase contains lithium, silicon, and oxygen, the silicon oxide phase includes SiO₂, the silicon oxide phase and the silicon phase are dispersed in the lithium silicate phase, and in a diffraction pattern by X-ray diffraction analysis (XRD) of the silicate composite particles, a ratio I_{A}/I_{B} of a maximum intensity I_{A} of a diffraction peak A attributed to a SiO₂ (011) plane of the silicon oxide phase appearing at around 2θ=26°, to a maximum intensity I_{B} of a diffraction peak B attributed to a Si (111) plane of the silicon phase appearing at around 2θ28° is 0.9 or more and 1.4 or less.

Another aspect of the present disclosure relates to a secondary battery, comprising: a positive electrode; a negative electrode; an electrolyte; and a separator interposed between the positive electrode and the negative electrode, wherein the negative electrode includes a current collector, and a negative electrode active material layer, and the negative electrode active material layer contains the above-described negative electrode active material for secondary batteries.

### Advantageous Effects of Invention

With a negative electrode active material for secondary batteries according to the present disclosure, it is possible to realize a secondary battery having excellent charge-discharge cycle characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic cross-sectional view of a negative electrode active material according to one embodiment of the present disclosure.

FIG. 2 A partially cut-away schematic oblique view of a secondary battery according to one embodiment of the present disclosure.

FIG. 3 A graph showing diffraction patterns by X-ray diffraction analysis (XRD) of silicate composite particles used in secondary batteries of Example 1 and Comparative Example 1.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” includes the numerical value A and the numerical value B, and can be rephrased as “a numerical value A or more and a numerical value B or less. In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

### [Negative Electrode Active Material for Secondary Batteries]

A negative electrode active material for secondary batteries according to an embodiment of the present disclosure includes silicate composite particles. The silicate composite particles each include a lithium silicate phase containing lithium (Li), silicon (Si), and oxygen (O), a silicon oxide phase including SiO₂, and a silicon phase (silicon particles), in which the silicon oxide phase and the silicon phase are dispersed in the lithium silicate phase. In the following, the “silicate composite particles” are sometimes referred to as “composite particles.”

In a diffraction pattern by X-ray diffraction analysis (XRD) of the silicate composite particles of the present embodiment, peaks attributed to the silicon oxide phase, the silicon phase, and the lithium silicate phase may appear. Specifically, in the range of 2θ=25° to 27° (hereinafter, sometimes referred to as “at around 2θ=26°”), a diffraction peak A attributed to the SiO₂ (011) plane of the silicon oxide phase is observed. In the range of 2θ=27° to 30° (hereinafter, sometimes referred to as “at around 2θ=28°”), a diffraction peak B attributed to the Si (111) plane of the silicon phase is observed. In the range of 2θ=23° to 25°, peaks attributed to the lithium silicate phase (Li₂Si₂O₅) may appear. However, because of much inclusion of amorphous phases therein, the peak intensities of the lithium silicate phase are small. For the X-ray used in the XRD analysis, the Kα ray of Cu is used.

Note that in the range of 2θ=18° to 20°, a peak attributed to lithium silicate Li₂SiO₃, and in the range of 2θ=20° to 21°, a peak attributed to SiO₂ may be further observed.

According to the negative electrode active material for secondary batteries according to an embodiment of the present disclosure, in a diffraction pattern by X-ray diffraction analysis (XRD) of the silicate composite particles, a ratio I_{A}/I_{B} of a maximum intensity I_{A} of a diffraction peak A attributed to the SiO₂ (011) plane of the silicon oxide phase appearing at around 2θ=26°, to a maximum intensity I_{B} of a diffraction peak B attributed to the Si (111) plane of the silicon phase appearing at around 2θ=28° is 0.9 or more and 1.4 or less. When the ratio I_{A}/I_{B} is 0.9 or more, the crystallinity of the silicon oxide phase in the silicate composite particles is enhanced. This can increase the hardness of the silicate composite particles, so that the cracks and breaks in the composite particle can be suppressed.

The ratio I_{A}/I_{B} is 0.9 or more, and the upper limit is not particularly limited. However, for ease of production of the silicate composite particles and realization of a secondary battery having excellent charge-discharge cycle characteristics, the ratio I_{A}/I_{B} can be 1.4 or less.

In the diffraction pattern, a half-value width W_{B} of the diffraction peak B attributed to Si contained in the silicon phase may be 0.3° or more and 1.5° or less on the 2θ basis. In the diffraction pattern, a half-value width W_{A} of the diffraction peak A attributed to SiO₂ contained in the silicon oxide phase may be 0.6° or less, and may be 0.2° or more and 0.6° or less, on the 2θ basis. When each of the half-value widths is within the above range, cracks and breaks in the silicate composite particles are significantly suppressed, and a secondary battery with excellent charge-discharge cycle characteristics is likely to be realized. In the present specification, the half-value width of the diffraction peak means a full width at half maximum (FWHM).

In the diffraction pattern, a ratio S_{A}/S_{B} of an integrated intensity S_{A} of the diffraction peak A to an integrated intensity S_{B} of the diffraction peak B may be 0.7 or less. In this case, the content ratio between the silicon phase and the silicon oxide phase dispersed in the lithium silicate phase is suitable, and a secondary battery with excellent charge-discharge cycle characteristics is likely to be realized using the silicate composite particles.

The maximum intensity, the half-value width, and the integrated intensity of the diffraction peaks A and B are each determined by analyzing an X-ray diffraction pattern using Cu-Kα ray. The diffraction peaks A and B are separated from the X-ray diffraction pattern. The maximum intensity, the half-value width, and the integrated intensity determined for the diffraction peak A after separation are denoted by I_{A}, W_{A}, and S_{A}, respectively. The maximum intensity, the half-value width, and the integrated intensity determined for the diffraction peak B after separation are denoted by I_{B}, W_{B}, and S_{B}, respectively. The S_{A} is determined by integrating the intensities of the diffraction peak A after separation over a range of diffraction angles 2θ of 25° to 27°. The S_{B} is determined by integrating the intensities of the diffraction peak B after separation over a range of diffraction angles 2θ of 27° to 30°.

The silicate composite particles are produced by, for example, mixing a lithium silicate and silicon particles, pulverizing the mixture using a ball mill or the like to form it into a composite, and sintering the pulverized mixture. The lithium silicate is obtained by mixing a silicon raw material (e.g., silicon dioxide) and a lithium raw material, followed by sintering. At this time, in the lithium silicate production process, when the silicon raw material is in excess relative to the lithium raw material, silicon oxide may be produced. The silicon oxide is crystallized in the sintering process after composite formation, and finely precipitates as a silicon oxide phase in the lithium silicate phase. The crystals of silicon oxide are stable and will not play a key role in irreversible reactions during charging, and they are so fine that they hardly hinders the expansion and contraction of the silicon phase.

The silicon oxide phase is harder and less flexible than the lithium silicate phase. By dispersing the silicon oxide phase, which has a high hardness, in the lithium silicate phase, the stress associated with expansion and contraction of the silicon phase can be dispersed throughout the lithium silicate phase, and the volume change of the silicate composite particles associated with expansion and contraction of the silicon phase can be suppressed. In addition, by enhancing the crystallinity of the silicon oxide phase, the volume change of the silicate composite particles can be further suppressed, leading to a realization of a negative electrode active material with favorable cycle characteristics.

The crystallinity of the silicon oxide phase can be controlled by changing the heating conditions and the pressure application conditions in sintering the mixture after composite formation, and by this, the maximum intensity I_{A}, the half-value width W_{A}, and the integrated intensity S_{A} of the diffraction peak A can be controlled. In sintering, a hot press may be used for pressure application. For example, with the applied pressure (surface pressure) set to 200 to 600 MPa and the heating temperature set to 600 to 1000° C., hot pressing is applied for 2 to 8 hours, and by this, silicate composite particles having an I_{A}/I_{B} ratio of 0.9 or more can be obtained. More preferably, with the applied pressure (surface pressure) set to 200 to 600 MPa and the heating temperature set to 750 to 950° C., hot pressing is applied for 2 to 6 hours, and by this, desired composite particles are likely to be obtained.

In synthesizing a lithium silicate, silicon dioxide having high crystallinity may be used as the silicon raw material. By controlling the feeding amount and/or the crystallinity of silicon dioxide added as the silicon raw material, the crystallinity of the silicon oxide phase dispersed in the lithium silicate phase in the silicate composite particles can be highly controlled, and silicate composite particles having an I_{A}/I_{B} ratio of 0.9 or more can be easily obtained.

In the silicate composite particles, the atomic ratio of O to Si (O/Si ratio) in the lithium silicate phase is, for example, more than 2 and less than 4. When the O/Si ratio is more than 2 and less than 4 (z in the formula described below is 0<z<2), it is advantageous in terms of stability and lithium-ion conductivity. Preferably, the O/Si ratio is more than 2 and less than 3 (z in the formula described below is 0<z<1). The atomic ratio of Li to Si (Li/Si ratio) in the lithium silicate phase is, for example, more than 0 and less than 4.

The lithium silicate phase includes an oxide phase represented by a chemical formula Li_{2z}SiO_{2+z} where 0<z<2. In view of the stability, the ease of production, the lithium-ion conductivity, and the like, z preferably satisfies the relationship 0<z<1, more preferably z=1/2.

The lithium silicate phase may include another element other than Li, Si, and O (oxygen). The lithium silicate phase may include, for example, at least one element selected from the group consisting of alkali metal elements (except Li) and Group II elements.

When an alkali metal element other than Li is contained in the lithium silicate phase, crystallization hardly proceeds, resulting in a low viscosity in the softened state, and a high fluidity. Therefore, even when heat treatment is performed at a low temperature, the gaps between the silicon phases are likely to be filled up, and dense composite particles are likely to be produced. The alkali metal element may be Na and/or K, because of their inexpensive prices. The atomic ratio (X/Li ratio) of the alkali element X (e.g., K) other than Li contained in the lithium silicate phase to Li is, for example, 0.1 to 7.1, may be 0.4 or more and 5 or less, and may be 0.7 or more and 2 or less.

The lithium silicate phase may contain a Group II element. In general, the silicate phase exhibits alkalinity, whereas the Group II element has an effect of suppressing the elution of alkali metals from the silicate phase. Therefore, the slurry viscosity tends to be stabilized when preparing a slurry containing a negative electrode active material. Therefore, the necessity of a treatment (e.g., an acid treatment) for neutralizing the alkali component in the silicate composite particles is also reduced. The content of the Group II element is, for example, 20 mol % or less, may be 15 mol % or less, and may be 10 mol % or less, relative to the total amount of the elements other than O contained in the lithium silicate phase.

The lithium silicate phase may contain an element M. The element M may be at least one selected from the group consisting of B, Al, Ca, Mg, Zr, Nb, Ta, La, V, Y, Ti, P, Bi, Zn, Sn, Pb, Sb, Co, Er, F and W. When the lithium silicate phase contains these elements M, the chemical stability and the lithium-ion conductivity of the composite particles are improved, and side reactions caused by contacts between the lithium silicate phase and the nonaqueous electrolyte can be suppressed. Specifically, for example, B has a low melting point and is advantageous for improving the fluidity during sintering. Ca, although acting to reduce the ion conductivity, has an effect of increasing the hardness of the lithium silicate phase. Al, Zr, Nb, Ta, and La can improve the hardness while maintaining the ion conductivity. Moreover, La forms, in the lithium silicate phase, a crystalline phase that is less reactive with lithium ions, and decreases the sites that can react with lithium ions within the lithium silicate phase. As a result, the irreversible capacity is decreased, and the initial charge-discharge efficiency is improved.

In view of the chemical resistance to liquid electrolyte and the structural stability, the element M is preferably at least one selected from the group consisting of Zr, Ti, P, Al, and B. The element M may form a compound. The compound may be, for example, a silicate of the element M or an oxide of the element M depending on the kind of the element M. The content of the element M is, for example, 20 mol % or less, may be 15 mol % or less, and may be 10 mol % or less, or 5 mol % or less, relative to the total amount of the elements other than O contained in the lithium silicate phase.

The contents of B, Na, K, and Al contained in the lithium silicate phase can be determined by a quantitative analysis in accordance with JIS R3105 (1995) (method for chemical analysis of borosilicate glass), and the Ca content can be determined by a quantitative analysis in accordance with JIS R3101 (1995) (method for chemical analysis of soda-lime glass).

The lithium silicate phase may further contain very small amounts of iron (Fe), chromium (Cr), nickel (Ni), manganese (Mn), copper (Cu), molybdenum (Mo), and other elements.

The elements contained in the composite particles are determined by the following method. First, a sample of the lithium silicate phase or silicate composite particles containing the lithium silicate phase is completely dissolved in a heated acid solution (a mixed acid of hydrofluoric acid, nitric acid, and sulfuric acid), and the carbon of the solution residue is removed by filtration. Thereafter, the resulting filtrate is analyzed by inductively coupled plasma atomic emission spectroscopy (ICP-AES), to measure the spectral intensity of each element. Subsequently, a calibration curve is created using commercially available standard solutions of elements, and the content of each of the elements in the Si-containing particles is calculated.

In the silicate composite particles, the lithium silicate phase, the silicon oxide phase, and the silicon phase are present, but they can be distinguished and quantitatively determined by using Si-NMR. The Si content obtained by ICP-AES as described above is the sum of the amount of Si constituting the silicon phase, the amount of Si in the lithium silicate phase, and the amount of Si in the silicon oxide phase. On the other hand, the amount of Si constituting the silicon phase can be quantitatively determined separately, using Si-NMR. Therefore, the amount of Si in the lithium silicate phase can be quantitatively determined by subtracting the amount of Si constituting the silicon phase and the amount of Si in the silicon oxide phase from the Si content determined by ICP-AES. Note that, as the standard substance necessary for quantitative determination, a mixture containing a silicate phase whose Si content is already known and a silicon phase in a predetermined ratio may be used.

Desirable Si-NMR measurement conditions are shown below.

### <Si-NMR Measurement Conditions>

Measuring apparatus: Solid nuclear magnetic resonance spectrometer (INOVA-400), available from Varian, Inc.
Probe: Varian 7 mm CPMAS-2
MAS: 4.2 kHz
MAS speed: 4 kHz
Pulse: DD (450 pulse+signal capture time 1H decoupling)
Repetition time: 1200 sec to 3000 sec
Observation width: 100 kHz
Observation center: around −100 ppm
Signal capture time: 0.05 sec
Number of times of accumulation: 560
Sample amount: 207.6 mg

In order to achieve high capacity and improve the cycle characteristics, the content of the silicon phase (silicon particles) in the silicate composite particles may be, for example, 30 mass % or more and 80 mass % or less. When the content of the silicon phase is 30 mass % or more, the proportion of the silicate phase is decreased, and the initial charge-discharge efficiency is likely to be improved. Besides, the diffusivity of lithium ions is favorable, and excellent load characteristics are likely to be obtained. When the content of the silicon phase is 80 mass % or less, the degree of expansion and contraction of the silicate composite particles during charging and discharging tends to be low, and the cycle characteristics are likely to be improved. The content of the silicon phase in the silicate composite particles is preferably 40 mass % or more, and more preferably 50 mass % or more.

The average particle diameter of the silicate composite particles is, for example, 1 μm or more and 25 μm or less, and may be 4 μm or more and 15 μm or less. When within the above particle diameter range, the stress caused by the volume change of the composite material during charging and discharging is easily reduced, and favorable cycle characteristics are likely to be obtained. The surface area of the composite particles becomes also suitable, and the capacity loss due to side reactions with the nonaqueous electrolyte is also suppressed. Here, the average particle diameter means a particle diameter (volume average particle diameter) at 50% cumulative volume in a particle size distribution measured by a laser diffraction scattering method. For the measurement instrument, for example, “LA-750” available from Horiba, Ltd. (HORIBA) can be used.

In the silicate composite particles, in view of suppressing cracks in the silicon phase itself due to charging and discharging, the average particle diameter of the silicon phases is, before initial charging, preferably 500 nm or less, more preferably 200 nm or less, even more preferably 50 nm or less. After initial charging, the average particle diameter of the silicon phases is preferably 400 nm or less, more preferably 100 nm or less. By making the silicon phase finer, the volume change during charging and discharging is reduced, and the structural stability of the composite particles is further improved. Furthermore, the expansion and contraction of the silicon phase are balanced, leading to suppressed particle cracking, and the cycle characteristics are likely to be improved. The average particle diameter of the silicon phases is measured using a cross-sectional image of the composite material obtained by a SEM. Specifically, the average particle diameter of the silicon phases is determined by averaging the maximum diameters of randomly selected 100 silicon phases.

The silicon phase dispersed in the lithium silicate phase has a particulate phase of silicon (Si) simple substance, and is constituted of a single or multiple crystallites. The crystallite size of the silicon phase is preferably 30 nm or less. When the crystallite size of the silicon phase is 30 nm or less, the stress caused by the volume change of the silicon phase is easily dispersed in the composite particles, and the cracks and breaks of the composite particles are suppressed. Furthermore, the amount of volume change due to the expansion and contraction of the silicon phase during charging and discharging can be reduced, and the cycle characteristics are further improved. For example, this can suppress the isolation of the silicon phase, which is caused by reduced contact points with its surroundings due to voids formed around the silicon phase when the silicon phase contracts, and thus, can suppress the reduction in charge-discharge efficiency due to the isolation of the silicon phase. The lower limit value of the crystallite size of the silicon phase is not particularly limited, but is, for example, 5 nm. When the crystallite size of the silicon phase is 5 nm or more, the surface area of the silicon phase can be kept small, and therefore, the deterioration of the silicon phase accompanied by the generation of irreversible capacity hardly occurs.

The crystallite size of the silicon phase is calculated using the Scherrer's formula from the half-value width of a diffraction peak belonging to the Si (111) plane in an X-ray diffraction (XRD) pattern of the silicon phase.

At least part of the surfaces of the silicate composite particles may be covered with a conductive material. The lithium silicate phase is poor in electronic conductivity, and the conductivity of the silicate composite particles also tends to be low. However, by covering the surfaces of the composite particles with a conductive material, to form a conductive layer, the conductivity of the silicate composite particles can be increased. The conductive material is preferably a carbon material. The carbon material preferably includes at least one selected from the group consisting of a carbon compound and a carbonaceous material.

The thickness of the conductive layer is preferably thin enough not to substantially influence the average particle diameter of the silicate composite particles. In light of the securement of conductivity and the diffusivity of lithium ions, the thickness of the conductive layer is preferably 1 to 200 nm, more preferably 5 to 100 nm. The thickness of the conductive layer can be measured by observing a cross section of the silicate composite particle using a SEM or a TEM (transmission electron microscope).

Examples of the carbon compound include a compound containing carbon and hydrogen, and a compound containing carbon, hydrogen, and oxygen. Examples of the carbonaceous material include amorphous carbon with low crystallinity, and graphite with high crystallinity. Examples of the amorphous carbon include carbon black, coal, coke, charcoal, and activated carbon. Examples of the graphite include natural graphite, artificial graphite, and graphitized mesophase carbon particles. In particular, amorphous carbon is preferred because of its low hardness and excellent buffering effect against the silicon phase that undergoes changes in volume during charging and discharging. The amorphous carbon may be graphitizable carbon (soft carbon), and may be non-graphitizable carbon (hard carbon). Examples of the carbon black include acetylene black and Ketjen black.

The silicate composite particles can be taken out from the battery in the following manner. First, the battery is disassembled to take out the negative electrode, which is then washed with anhydrous ethyl methyl carbonate or dimethyl carbonate, to remove the liquid electrolyte. Next, the negative electrode mixture is scraped off from the copper foil, and pulverized in a mortar, to obtain a sample powder. Next, the sample powder is dried in a dry atmosphere for 1 hour, and immersed in a weakly boiled 6M hydrochloric acid for 10 minutes, to remove alkali metals, such as Na and Li, optionally contained in the binder, etc. Next, the sample powder is washed with ion-exchanged water, and after filtration, dried at 200° C. for 1 hour. This is followed by heating to 900° C. in an oxygen atmosphere, to remove the carbon component. Thus, only the silicate composite particles can be isolated.

The cross-section observation of the silicate composite particles can be performed, for example, in the following manner. First, the battery is disassembled, to take out the negative electrode, and obtain a cross section of the negative electrode mixture layer using a cross-section polisher (CP). The cross section of the negative electrode mixture layer is observed with a scanning electron microscope (SEM). From the cross-sectional image of a backscattered electron image of the negative electrode mixture layer, 10 particles of the silicon-containing material having a maximum diameter of 5 μm or more are randomly selected, on each of which an elemental mapping analysis by energy dispersive X-ray (EDX) is performed. The area occupied by a target element is calculated using an image analysis software. The observation magnification is desirably 2,000 to 20,000 times. The measured values of the area occupied by a predetermined element obtained for 10 particles are averaged. The content of the target element is calculated from the obtained average value. The composition of the lithium silicate phase is calculated from the content of the element.

It should be noted here that, during charging and discharging, a surface film is formed on the silicate composite particles due to the decomposition of the electrolyte or other causes. Also, there is a case where the silicate composite particles has a conductive layer covering the surfaces of the composite particles. In light of this, the mapping analysis by EDX is performed on a region 1 μm or more inward from the peripheral edge of the cross section of the composite particle so that the measurement range includes neither the surface film nor the conductive layer. The mapping analysis by EDX can also confirm the distribution state of the carbon material inside the silicate composite particles. The measurement of the sample is preferably performed before cycling or in the early stage of cycling because, in the late stage of cycling, it is difficult to make a distinction from decomposition products of the electrolyte.

Desirable cross-sectional SEM-EDX analysis measurement conditions are shown below.

### <SEM-EDX Measurement Conditions>

Processing apparatus: SM-09010 (Cross Section Polisher) available from JEOL
Processing conditions: accelerating voltage: 6 kV
Current value: 140 μA
Degree of vacuum: 1×10⁻³ to 2×10⁻³ Pa
Measuring apparatus: Electron microscope SU-70 available from HITACHI
Acceleration voltage during analysis: 10 kV
Field: Free mode
Probe current mode: Medium
Probe current range: High
Anode Ap.: 3
OBJAp.: 2
Analysis area: 1 μm square
Analysis software: EDAX Genesis
CPS: 20,500
Lsec: 50
Time constant: 3.2

The content of each element in the silicate composite particles contained in the negative electrode active material in a discharge state can be determined by SEM-EDX analysis, or other methods, such as Auger electron spectroscopy (AES), laser ablation ICP mass spectrometry (LA-ICP-MS), and X-ray photoelectron spectroscopy (XPS).

### [Manufacturing Method of Negative Electrode Active Material for Secondary Batteries]

Next, an example of a manufacturing method of silicate composite particles will be described in detail.

The method for producing a negative electrode active material for secondary batteries includes, for example, a step (i) of obtaining lithium silicate, and a step (ii) of forming the lithium silicate into a composite with raw material silicon, to obtain composite particles in which a silicon phase and a silicon oxide phase are dispersed in a lithium silicate phase.

### Step (i)

As the raw material of a lithium silicate, a raw mixture including a Si-containing raw material and a Li raw material in a predetermined ratio is used. The aforementioned element M may be included in the raw mixture. A lithium silicate is produced by melting a mixture of predetermined amounts of the aforementioned raw materials, and passing the melt between metal rolls, into flakes. Then, flakes of the silicate are crystalized by heat treatment in an atmospheric air at a temperature equal to or higher than the glass transition point, and equal to or lower than the melting point. Alternatively, flakes of the silicate may be used without being crystalized. A silicate can also be produced by firing a mixture of predetermined amounts of the raw materials, without being melted, at a temperature equal to or lower than the melting point, to cause a solid-phase reaction. The heat treatment is performed, for example, in an oxidizing atmosphere. The heat treatment temperature is preferably 400° C. or more and 1200° C. or less, and more preferably 800° C. or more and 1100° C. or less.

As the Si raw material, silicon oxide can be used. As the Li raw material, for example, lithium carbonate, lithium oxide, lithium hydroxide, lithium hydride, and the like can be used. These may be used singly or in combination of two or more kinds. The raw material of the element M may be an oxide, a hydroxide, a carbonate compound, a hydride, a nitrate, a sulfate, etc. of each element.

In the lithium silicate, the Si raw material that has not reacted with the Li raw material may remain.

### Step (ii)

Next, the lithium silicate is blended with a silicon raw material, to be formed into a composite. For example, composite particles are produced through the following steps (a) to (c).

### Step (a)

First, powder of raw material silicon and powder of the lithium silicate are mixed in a mass ratio of, for example, 20:80 to 95:5. For the raw material silicon, coarse silicon particles with an average particle diameter of several m to several tens of m may be used.

### Step (b)

Next, the mixture of the raw material silicon and the lithium silicate is pulverized under application of a shear force thereto, so that the mixture is formed into a composite while being pulverized into fine particles. For example, a raw material silicon and a lithium silicate are mixed in a predetermined mass ratio, and stirred while the mixture is pulverized into fine particles using a pulverizer, such as a ball mill. At this time, an organic solvent may be added to the mixture, to perform wet-pulverization. A predetermined amount of the organic solvent may be fed into a pulverization vessel all at once in the early stage of the pulverization, or a predetermined amount of the organic solvent may be intermittently fed into a pulverization vessel dividedly in several times during the pulverization. The organic solvent serves to prevent the adhesion of a pulverization target onto the inner wall of the pulverization vessel.

As the organic solvent, an alcohol, an ether, a fatty acid, an alkane, a cycloalkane, a silicate, a metal alkoxide, and the like can be used.

Note that the silicon raw material and the lithium silicate may be mixed after being separately pulverized into fine particles. Alternatively, without using a pulverizer, silicon nanoparticles and amorphous lithium silicate nanoparticles may be produced, and they may be mixed together. For the production of the nanoparticles, a known method, such as a gas phase method (e.g., plasma method) and a liquid phase method (e.g., liquid phase reduction method), may be used.

### Step (c)

Next, the mixture is heated and applied with pressure in an inert gas atmosphere (e.g., an atmosphere of argon, nitrogen, etc.), to be sintered. The pressure application may be performed simultaneously (or in parallel) with heating, or may be performed after heating. The pressure application is performed within the time period in which the high temperature state by heating is maintained. For sintering, a sintering device capable of applying pressure under an inert atmosphere, such as a hot press, may be used. During sintering, the lithium silicate is softened, and flows so as to fill the gaps between the silicon particles. As a result, a dense block-shaped sintered body which contains the silicate phase as a sea portion and the silicon oxide phase and the silicon phase as island portions can be obtained.

The heating temperature is preferably 600° C. or more and 1000° C. or less. When the heating temperature is in the above range, the fine silicon phase can be easily dispersed in the silicate phase with low crystallinity. The raw silicate is stable in the above temperature range and hardly reacts with silicon, and therefore, a capacity drop, if any, is very small.

Pulverizing the obtained sintered body provides silicate composite particles. By appropriately selecting the pulverizing conditions, silicate composite particles having a predetermined average particle diameter can be obtained.

Step (iii)

Next, at least part of the surfaces of the composite particles may be covered with a conductive material, to form a conductive layer. The conductive material is preferably electrochemically stable, and is preferably a conductive carbon material. As a method for covering the surfaces of the composite particles with a conductive carbon material, for example, a CVD method using a hydrocarbon gas, such as acetylene or methane, as a raw material, and a method of mixing coal pitch, petroleum pitch, phenolic resin, etc. with the composite particles and carbonizing them by heating, can be used. Alternatively, carbon black may be attached to the surfaces of the composite particles. The covering with a conductive carbon material can be performed by, for example, heating a mixture of the particles from which fine particles have been removed and the conductive carbon material, at 700° C. to 950° C., in an inert atmosphere (e.g., an atmosphere of argon, nitrogen, etc.).

### Step (iv)

A step of washing the composite particles (including those having conductive layers on the surfaces thereof) with acid may be performed. For example, by washing the composite particles with an acidic aqueous solution, a very small amount of an alkali component, which may have been produced when forming the silicon raw material and the lithium silicate into a composite, on the surfaces of the composite particles can be dissolved and removed. As the acidic aqueous solution, an aqueous solution of an inorganic acid, such as hydrochloric acid, hydrofluoric acid, sulfuric acid, nitric acid, phosphoric acid, and carbonic acid, or an aqueous solution of an organic acid, such as citric acid and acetic acid, can be used.

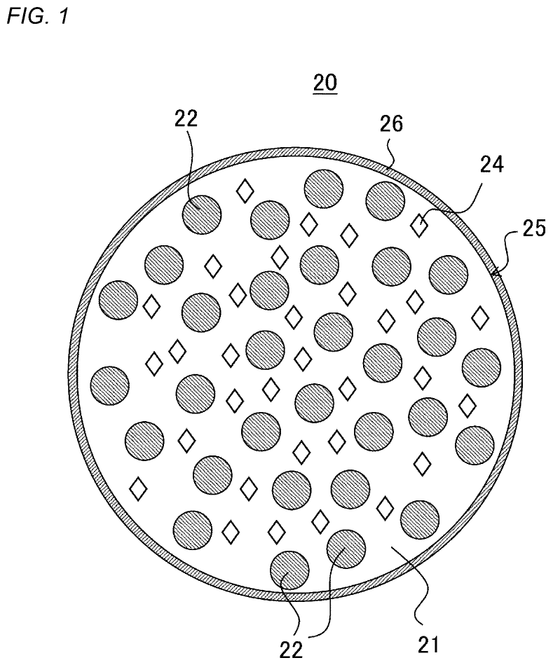

A cross section of a silicate composite particle 20 as an example of the negative electrode active material is schematically illustrated in FIG. 1.

Abase particle 25 includes a lithium silicate phase 21, and silicon (simple substance Si) particles 22 dispersed in the silicate phase 21, and a silicon oxide phase 24 dispersed in the lithium silicate phase 21. The surface of the mother particle 25 is covered with a conductive layer 26, forming a silicate composite particle 20.

The silicate composite particle 20 has, for example, a sea-island structure, and in a cross section thereof, the fine silicon phase 22 and the fine silicon oxide phase 24 are approximately uniformly scattered in the matrix of the lithium silicate phase 21 without being localized in some regions. The SiO₂ content in the base particle 25 measured by Si-NMR is, for example, preferably 30 mass % or less, more preferably less than 7 mass %.

The base particle 25 may contain other components, in addition to the lithium silicate phase 21, the silicon phase 22, and the silicon oxide phase 24. For example, in view of improving the strength of the base particle 25, a reinforcing material, such as an oxide like ZrO₂ or a carbide, may be contained in an amount of less than 10 wt % of the base particle 25.

### [Secondary Battery]

A secondary battery according to an embodiment of the present disclosure includes a positive electrode, a negative electrode, an electrolyte, and a separator interposed between the positive electrode and the negative electrode. The negative electrode includes a current collector, and a negative electrode active material layer including the above-described negative electrode active material for secondary batteries. The secondary battery may be a nonaqueous electrolyte secondary battery.

Detailed description will be given below of the negative electrode, the positive electrode, the electrolyte, and the separator included in the secondary battery according to an embodiment of the present disclosure.

### [Negative Electrode]

The negative electrode includes, for example, a negative electrode current collector, and a negative electrode mixture layer formed on a surface of the negative electrode current collector and containing a negative electrode active material. The negative electrode mixture layer can be formed by applying a negative electrode slurry of a negative electrode mixture dispersed in a dispersion medium, onto a surface of the negative electrode current collector, followed by drying. The dry applied film may be rolled as necessary. The negative electrode mixture layer may be formed on one surface or on both surfaces of the negative electrode current collector.

The negative electrode mixture contains, as the negative electrode active material, the above-described negative electrode active material for secondary batteries containing silicate composite particles as an essential component, and can contain as optional components, a binder, a conductive agent, a thickener, and the like. The silicon phase in the silicate composite particles can absorb much amount of lithium ions, and thus, contributes to achieving high capacity of the negative electrode.

The negative electrode active material may further include another active material ingredient that electrochemically absorbs and desorb lithium ions. For example, a carbon-based active material is preferred as another active material ingredient. The volume of the silicate composite particles expands and contracts in association with charging and discharging. Therefore, when the ratio thereof in the negative electrode active material increases, a contact failure between the negative electrode active material and the negative electrode current collector tends to occur in association with charging and discharging. On the other hand, by using the silicate composite particles in combination with a carbon-based active material, it becomes possible to achieve excellent cycle characteristics, while imparting the high capacity of the silicon phase to the negative electrode. The proportion of the silicate composite particles relative to the total of the silicate composite particles and the carbon-based active material is, for example, preferably 0.5 to 15 mass %, more preferably 1 to 5 mass %. By this, both high capacity and improvement of cycle characteristics are likely to be achieved.

Examples of the carbon-based active material include graphite, graphitizable carbon (soft carbon), and non-graphitizable carbon (hard carbon). In particular, preferred is graphite, which is stable during charging and discharging and whose irreversible capacity is small. Graphite means a material having a graphite-like crystal structure, examples of which include natural graphite, artificial graphite, and graphitized mesophase carbon particles. The carbon material may be used singly or in combination of two or more kinds.

As the negative electrode current collector, a non-porous conductive substrate (metal foil, etc.) or a porous conductive substrate (mesh, net, punched sheet, etc.) is used. Examples of the material of the negative electrode current collector include stainless steel, nickel, nickel alloy, copper, and copper alloy. The thickness of the negative electrode current collector is not particularly limited, but is preferably 1 to 50 m, more preferably 5 to m, in view of the balance between high strength and lightweight of the negative electrode.

Examples of the binder include fluorocarbon resins, polyolefin resins, polyamide resins, polyimide resins, vinyl resins, styrene-butadiene copolymer rubber (SBR), polyacrylic acids, and derivatives thereof. These may be used singly or in combination of two or more kinds. Examples of the conductive agent include carbon black, conductive fibers, carbon fluoride, and organic conductive materials. These may be used singly or in combination of two or more kinds. Examples of the thickener include carboxymethyl cellulose (CMC), and polyvinyl alcohol. These may be used singly or in combination of two or more kinds.

Examples of the dispersion medium include water, alcohols, ethers, N-methyl-2-pyrrolidone (NMP), and mixed solvents thereof

### [Positive Electrode]

The positive electrode includes, for example, a positive electrode current collector, and a positive electrode mixture layer formed on a surface of the positive electrode current collector. The positive electrode mixture layer can be formed by applying a positive electrode slurry of a positive electrode mixture dispersed in a dispersion medium, onto a surface of the positive electrode current collector, followed by drying. The dry applied film may be rolled as necessary. The positive electrode mixture layer may be formed on one surface or on both surfaces of the positive electrode current collector.

The positive electrode mixture includes a positive electrode active material as an essential component, and can include a binder, a conductive agent, and the like as optional components.

As the positive electrode active material, a lithium-composite metal oxide can be used. Examples of the lithium-composite metal oxide include LiₐCoO₂, LiₐNiO₂, LiₐMnO₂, LiₐCO_{b}Ni_{1-b}O₂, LiₐCO_{b}M_{1-b}O_{c}, LiₐNi_{1-b}M_{b}O_{c}, LiₐMn₂O₄, LiₐMn_{2-b}M_{b}O₄, LiMePO₄, and Li₂MePO₄F. Here, M is at least one selected from the group consisting of Na, Mg, Sc, Y, Mn, Fe, Co, Ni, Cu, Zn, Al, Cr, Pb, Sb, and B. Me includes at least a transition element (e.g., at least one selected from the group consisting of Mn, Fe, Co, and Ni). Here, 0≤a≤1.2, 0≤b≤0.9, and 2.0≤c≤2.3. The value “a” representing the molar ratio of lithium increases and decreases during charging and discharging.

In particular, preferred is a lithium-nickel-composite oxide represented by LiₐNi_{b}Me_{1-b}O₂ where Me is at least one selected from the group consisting of Mn, Co, and Al, 0<a≤1.2, and 0.3≤b≤1. In view of achieving high capacity, preferably, 0.85≤b<1. In view of the stability of the crystal structure, more preferred is LiₐNi_{b}Co_{c}Al_{d}O₂ containing Co and Al as elements represented by Me, where 0<a≤1.2, 0.85≤b<1, 0<c<0.15, 0<d≤0.1, and b+c+d=1.

As the binder and the conductive agent, those as exemplified for the negative electrode can be used. As the conductive agent, graphite, such as natural graphite and artificial graphite, may also be used.

The shape and the thickness of the positive electrode current collector can be respectively selected from the shapes and the ranges corresponding to those of the negative electrode current collector. Examples of the material of the positive electrode current collector include stainless steel, aluminum, aluminum alloy, and titanium.

### [Electrolyte]

The electrolyte contains a solvent, and a lithium salt dissolved in the solvent. The concentration of the lithium salt in the electrolyte is, for example, 0.5 to 2 mol/L. The electrolyte may contain a known additive.

The solvent may be an aqueous solvent or a nonaqueous solvent. As the nonaqueous solvent, for example, a cyclic carbonic acid ester, a chain carbonic acid ester, a cyclic carboxylic acid ester, and the like are used. Examples of the cyclic carbonic acid ester include propylene carbonate (PC), and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL), and γ-valerolactone (GVL). The nonaqueous solvent may be used singly or in combination of two or more kinds.

Examples of the lithium salt include a lithium salt of a chlorine-containing acid (LiClO₄, LiAlCl₄, LiB₁₀Cl₁₀, etc.), a lithium salt of a fluorine-containing acid (LiPF₆, LiBF₄, LiSbF₆, LiAsF₆, LiCF₃SO₃, LiCF₃CO₂, etc.), a lithium salt of a fluorine-containing acid imide (LiN(CF₃SO₂)₂, LiN(CF₃SO₂)(C₄F₉SO₂), LiN(C₂F₅SO₂)₂, etc.), and a lithium halide (LiCl, LiBr, LiI, etc.). The lithium salt may be used singly or in combination of two or more kinds.

### [Separator]

Usually, it is desirable to interpose a separator between the positive electrode and the negative electrode. The separator is excellent in ion permeability and has moderate mechanical strength and electrically insulating properties. As the separator, for example, a microporous thin film, a woven fabric, a nonwoven fabric, and the like can be used. As the material of the separator, for example, a polyolefin, such as polypropylene and polyethylene, can be used.

One example of the structure of the secondary battery is a structure in which an electrode group formed by winding the positive electrode and the negative electrode with the separator interposed therebetween is housed in an outer body, together with the electrolyte. The wound-type electrode group may be replaced with a different form of electrode group, such as a stacked-type electrode group formed by stacking the positive electrode and the negative electrode with the separator interposed therebetween. The secondary battery may be in any form, such as cylindrical type, prismatic type, coin type, button type, and laminate type.

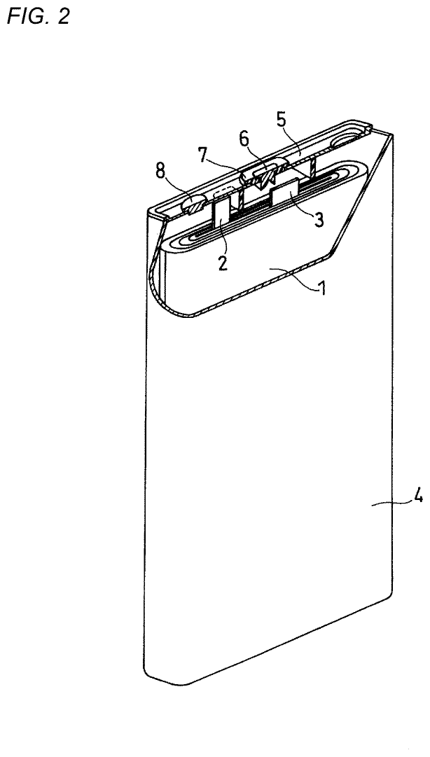

FIG. 2 is a partially cut-away schematic oblique view of a prismatic secondary battery according to one embodiment of the present disclosure.

The battery includes a bottomed prismatic battery case 4, an electrode group 1 and an electrolyte (not shown) housed in the battery case 4, and a sealing plate 5 sealing the opening of the battery case 4. The electrode group 1 includes a long negative electrode, a long positive electrode, and a separator interposed therebetween. The negative electrode, the positive electrode, and the separator are wound around a flat plate-like winding core, and thereafter, the winding core is removed, so that the electrode group 1 is formed. The sealing plate 5 has a liquid injection port closed by a sealing plug 8, and a negative electrode terminal 6 insulated from the sealing plate 5 by a gasket 7.

To the negative electrode current collector of the negative electrode, a negative electrode lead 3 is attached at its one end by welding or the like. To the positive electrode current collector of the positive electrode, a positive electrode lead 2 is attached at its one end by welding or the like. The other end of the negative electrode lead 3 is electrically connected to the negative electrode terminal 6. The other end of the positive electrode lead 2 is electrically connected to the sealing plate 5. On top of the electrode group 1, a resin frame body providing separation between the electrode group 1 and the sealing plate 5 and providing separation between the negative electrode lead 3 and the battery case 4 is disposed.

In the following, a secondary battery according to the present disclosure will be specifically described by way of Examples and Comparative Examples. The present disclosure, however, is not limited to the following Examples.

### Example 1

### [Preparation of Silicate Composite Particles]

Lithium carbonate and silicon dioxide were mixed in a molar ratio of Li₂CO₃:SiO₂=34:66. The mixture was melted in an inert gas atmosphere at 1100° C. for 5 hours, and the melt was passed between metal rolls, into flakes, which were then subjected to heat treatment in air at 750° C. for 5 hours, to obtain a lithium silicate composite oxide present as an amorphous-crystalline mixed phase. The obtained lithium silicate composite oxide was pulverized to have an average particle diameter of 10 μm.

The lithium silicate composite oxide having an average particle diameter of 10 m and raw material silicon (3N, average particle diameter 10 μm) were mixed in a mass ratio of 70:30. The mixture was packed in a pot (made of SUS, volume: 500 mL) of a planetary ball mill (P-5, available from Fritsch Co., Ltd.). Then, 24 SUS balls (diameter 20 mm) were put into the pot, and with the lid closed, the mixture was pulverized at 200 rpm for 25 hours, in an inert atmosphere.

Next, powder of the mixture was taken out in an inert atmosphere, and fired at 800° C. for 4 hours in an inert atmosphere, under application of pressure by a hot press machine, to obtain a sintered body of the mixture.

Thereafter, the sintered body was pulverized, and passed through a 40-μm mesh, and then, mixed with coal pitch (MCP250, available from JFE Chemical Corporation). The mixture was fired at 800° C. for 5 hours in an inert atmosphere, to cover the surfaces of the silicate composite particles with conductive carbon, to form a conductive layer. The covering amount of the conductive layer was set to 5 mass % relative to the total mass of the silicate composite particles and the conductive layer. Then, using a sieve, silicate composite particles of 5 μm in average particle diameter having a conductive layer were obtained.

The silicate composite particles were subjected to XRD analysis, to measure peaks attributed to Si and SiO₂.

### [Production of Negative Electrode]

The silicate composite particles and graphite were mixed in a mass ratio of 5:95, and the mixture was used as a negative electrode active material. The negative electrode active material, carboxymethyl cellulose sodium (CMC-Na), styrene-butadiene rubber (SBR), lithium polyacrylate were mixed in a mass ratio of 96.5:1:1.5:1, to which water was added, and then, the mixture was stirred using a mixer (T.K. HIVIS MIX, available from PRIMIX Corporation), to prepare a negative electrode slurry. Next, the negative electrode slurry was applied onto a surface of copper foil such that the mass of the negative electrode mixture per 1 m² of the copper foil was 190 g, and the applied film was dried, followed by rolling, to produce a negative electrode with a negative electrode mixture layer having a density of 1.5 g/cm³ formed on both sides of the copper foil.

### [Production of Positive Electrode]

Lithium cobalt oxide, acetylene black, and polyvinylidene fluoride were mixed in a mass ratio of 95:2.5:2.5, to which N-methyl-2-pyrrolidone (NMP) was added, and then, the mixture was stirred using a mixer (T.K. HIVIS MIX, available from PRIMIX Corporation), to prepare a positive electrode slurry. Next, the positive electrode slurry was applied onto a surface of aluminum foil, and the applied film was dried, followed by rolling, to produce a positive electrode with a positive electrode mixture layer having a density of 3.6 g/cm³ formed on both sides of the aluminum foil.

### [Preparation of Liquid Electrolyte]

In a mixed solvent mixture containing ethylene carbonate (EC) and diethyl carbonate (DEC) in a volume ratio of 3:7, LiPF₆ was dissolved at a concentration of 1.0 mol/L, to prepare a nonaqueous liquid electrolyte.

### [Fabrication of Secondary Battery]

The positive electrode and the negative electrode, with a tab attached to each electrode, were wound spirally with a separator interposed therebetween such that the tab was positioned at the outermost layer, thereby to form an electrode group. The electrode group was inserted in an outer body made of aluminum laminated film, and vacuum-dried at 105° C. for 2 hours, into which the nonaqueous liquid electrolyte was injected. The opening of the outer body was sealed. A secondary battery A1 was thus obtained.

### [Charge-Discharge Cycle Test]

With respect to the secondary battery A1, charging and discharging were repeated under the following conditions.

### <Charging>

At 25° C., constant-current charging was performed at a current of 1 It (800 mA) until the voltage reached 4.2 V, and then, constant-voltage charging was performed at a voltage of 4.2 V until the current reached 1/20 It (40 mA).

### <Discharging>

At 25° C., constant-current discharging was performed at a constant current of 1 It (800 mA) until the voltage reached 2.75 V.

The rest period between charging and discharging was set to 10 minutes. The ratio of a discharge capacity at the 200th cycle to a discharge capacity at the 1st cycle was evaluated as a cycle retention rate.

### Examples 2 and 3, and Comparative Example 1

In the preparation of silicate composite particles, the applied pressure, the heating temperature, and/or the heating time by the hot press machine were changed as follows. Except for this, negative electrodes were produced in the same manner as in Example 1, and secondary batteries A2, A3, and B1 were fabricated using the produced negative electrodes.

In Example 2, the heating temperature by the hot press machine was changed from 800° C. to 750° C.

In Example 3, the heating temperature by the hot press machine was changed from 800° C. to 850° C.

In Comparative Example 1, the applied pressure, the heating temperature, and the heating time by the hot press machine were changed respectively from 400 MPa to 180 MPa, from 800° C. to 600° C., and from 4 hours to 5 hours.

The secondary battery A2, the secondary battery A3, and the secondary battery B1 correspond respectively to Example 2, Example 3, and Comparative Example 1. With respect to the secondary batteries A2, A3, and B1, the cycle retention rates were evaluated in the same manner.

The cycle retention rates of the secondary batteries A1 to A3, and B1 are shown in Table 1. In Table 1, the ratio I_{A}/I_{B} of a maximum intensity I_{A} of the diffraction peak A attributed to the SiO₂ (011) plane of the silicon oxide phase, to a maximum intensity Is of the diffraction peak B attributed to the Si (111) plane of the silicon phase in the silicate composite particles used in each battery are shown. In Table 1, a half-value width W_{A} of the diffraction peak A, a half-value width W_{B} of the diffraction peak B, and the ratio S_{A}/S_{B} of an integrated intensity S_{A} of the diffraction peak A to an integrated intensity S_{B} of the diffraction peak B are also shown.

TABLE 1

| | silicate composite particles | | | | cycle |
|---|---|---|---|---|---|
| secondary | | W_{A} | W_{B} | | retention rate |
| battery | I_{A}/I_{B} | (°/2θ) | (°/2θ) | S_{A}/S_{B} | (%) |
| A1 | 1.09 | 0.33 | 0.66 | 0.49 | 85.9 |
| A2 | 0.98 | 0.31 | 0.63 | 0.43 | 85.8 |
| A3 | 1.15 | 0.33 | 0.65 | 0.52 | 85.9 |
| B1 | 0.51 | 0.41 | 0.61 | 0.30 | 84.9 |

Table 1 shows that in the secondary batteries A1 to A3 in which the I_{A}/I_{B} was 0.9 or more, the cycle retention rates were high, as compared to in the secondary battery B1 in which the I_{A}/I_{B} was less than 0.9.

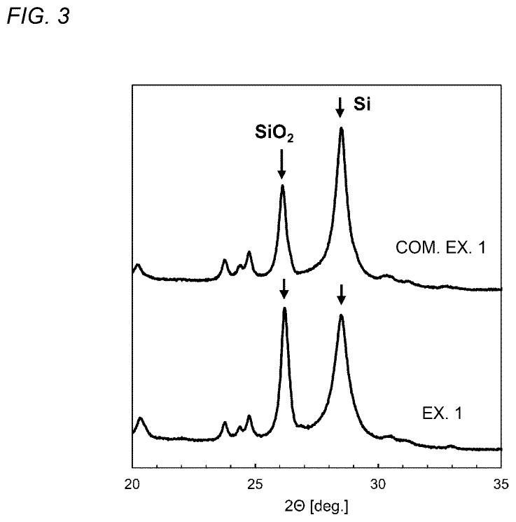

In FIG. 3, diffraction patterns by X-ray diffraction analysis (XRD) of the silicate composite particles used in the secondary battery A1 of Example 1 and the silicate composite particles used in the secondary battery B1 of Comparative Example 1 are shown. In both of the silicate composite particles used in Example 1 and Comparative Example 1, there observed a diffraction peak A attributed to the SiO₂ (011) plane of the silicon oxide phase and a diffraction peak B attributed to the Si (111) plane of the silicon phase. However, when focus is on the diffraction peak A, the diffraction peak A in Example 1 is sharper than that in Comparative Example 1, and the maximum intensity of the peak is also high. This means that in the silicate composite particles used in Example 1, the crystallinity of the silicon oxide phase was enhanced, as compared to in the silicate composite particles used in Comparative Example 1. When the silicon oxide phase with enhanced crystallinity is dispersed in the composite particles, cracks and breaks in the composite particles can be suppressed, and the charge-discharge cycle characteristics can be improved.

### INDUSTRIAL APPLICABILITY

The secondary battery according to the present disclosure is useful as a main power source for mobile communication devices, portable electronic devices, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: electrode group, 2: positive electrode lead, 3: negative electrode lead, 4: battery case, 5: sealing plate, 6: negative electrode terminal, 7: gasket, 8: sealing plug, 20: silicate composite particle, 21: lithium silicate phase, 22: silicon phase, 24: silicon oxide phase, 25: base particle, 26: conductive layer

1. A negative electrode active material for secondary batteries, comprising:
silicate composite particles, wherein
the silicate composite particles each include a lithium silicate phase, a silicon oxide phase, and a silicon phase,
the lithium silicate phase contains lithium, silicon, and oxygen,
the silicon oxide phase includes SiO₂,
the silicon oxide phase and the silicon phase are dispersed in the lithium silicate phase, and
in a diffraction pattern by X-ray diffraction analysis (XRD) of the silicate composite particles, a ratio I_{A}/I_{B} of a maximum intensity I_{A} of a diffraction peak A attributed to a SiO₂ (011) plane of the silicon oxide phase appearing at around 2θ=26°, to a maximum intensity I_{B} of a diffraction peak B attributed to a Si (111) plane of the silicon phase appearing at around 2θ=28° is 0.9 or more and 1.4 or less.

2. The negative electrode active material for secondary batteries according to claim 1, wherein in the diffraction pattern, a half-value width W_{B} of the diffraction peak B is 0.3° or more and 1.5° or less on a 2θ basis.

3. The negative electrode active material for secondary batteries according to claim 1, wherein in the diffraction pattern, a half-value width W_{A} of the diffraction peak A is 0.6° or less on a 2θ basis.

4. The negative electrode active material for secondary batteries according to claim 1, wherein in the diffraction pattern, a ratio S_{A}/S_{B} of an integrated intensity S_{A} of the diffraction peak A to an integrated intensity S_{B} of the diffraction peak B is 0.7 or less.

5. The negative electrode active material for secondary batteries according to claim 1, wherein
the lithium silicate phase further contains an element M, and
the element M is at least one selected from the group consisting of B, Al, Ca, Mg, Zr, Nb, Ta, La, V, Y, Ti, P, Bi, Zn, Sn, Pb, Sb, Co, Er, F, and W.

6. A secondary battery, comprising:
a positive electrode; a negative electrode; an electrolyte; and a separator interposed between the positive electrode and the negative electrode, wherein
the negative electrode includes a current collector, and a negative electrode active material layer, and
the negative electrode active material layer contains the negative electrode active material for secondary batteries of claim 1.
